(19) United States
(12) Patent Application Publication
(10) Pub. No.: US 2005/0155346 A1
(43) Pub. Date: Jul. 21, 2005

(54) Wind power machine

(76) Inventor: Thomas Nikolaus, Engen (DE)

Correspondence Address: BACHMAN & LAPOINTE, P.C., 900 CHAPEL STREET, SUITE 1201, NEW HAVEN, CT, 06510, US

(21) Appl. No.: 10/758,842

(22) Filed: Jan. 16, 2004

(51) Int. Cl. F16D 31/02

(52) U.S. Cl. 60/398

(57) ABSTRACT

A wind power machine for production of energy, comprises at least one rotor element (5) which can be driven by the wind and having an output load (15), in particular a generator (16), which is connected directly or indirectly to it, the rotor element (5) is intended to drive one or more hydraulic pumps (7) directly or indirectly.

### BACKGROUND OF THE INVENTION

The present invention relates to a wind power machine for production of energy, having at least one rotor element which can be driven by the wind, and an output load, in particular a generator, which is connected directly or indirectly to it.

Wind power machines such as these are commercially available in many different forms and embodiments and are used for the production of energy, in particular for electricity generation. Conventional wind power machines are generally formed from a pylon, to which a pylon attachment is fitted such that it can rotate. A generator, possibly a transmission and a rotor element connected to it are mounted in this pylon attachment.

The rotor element is driven by the wind and transmits a rotary movement, possibly via an intermediate transmission, directly to a generator.

This has the disadvantage that the weight of the generator, in particular of a very high-power generator, is at a very high level, and very severe oscillations often occur when the wind loads are high with very large wind power machines with tall pylons, so that the wind power machine must be switched off.

A further disadvantage is that the heavy weight of the generator, in particular, makes installation more difficult since costly cranes are required in order to fit the pylon attachment to the pylon.

A further disadvantage is that the maintenance work on the generator and, if appropriate, on the intermediate transmission element is carried out in the pylon attachment, and the maintenance personnel have to enter the pylon attachment, which is time-consuming. Spare parts must likewise also be transported up into the pylon attachment.

A further disadvantage with conventional wind power machines or wind parks is that, when the wind speeds are very high, they must be switched off owing to the very high rotation speeds of the rotor element, in order to prevent the wind power machines from oscillating in a correspondingly dangerous manner.

Furthermore, as is evident from the Weibull distribution, only quite specific wind spectra or ranges can be used and converted to a power output optimally, and this is disadvantageous. A further disadvantage is that only a quite specific proportion of the energy is utilized, by means of conventional technology. Furthermore, wind power machines such as these must be positively controlled in particular with respect to rotation of the pylon attachment, which likewise involves costs and control complexity.

DE 32 15 571 A1 discloses a method and an apparatus for improving the operating characteristics of a wind energy converter. This is used for hydraulic energy transmission, in order to drive a low-down pump.

DE 38 08 536 discloses a wind power system for production of drinking water, using the reverse osmosis method. Untreated water for supplying the drinking water system is pumped into a pylon by means of the reduced pressure that is produced by a pump set that is in the form of a centrifugal pumps.

DE 26 23 233 relates to an arrangement for matching a windmill to an electrical generator, with the torque of the rotor being introduced directly to the AC generator.

It is an object of the present invention to provide a wind power machine of the type mentioned initially which overcomes the stated disadvantages, and by means of which the amount of energy which is taken from the wind by the wind power machine is increased significantly in a cost-effective and effective manner, so that the overall efficiency of a wind power machine is improved. A further aim is to minimize the maintenance costs, production costs and installation costs, and to increase the power output and life of the wind power machine.

### SUMMARY OF THE INVENTION

The foregoing object is achieved by way of the present invention wherein a wired power machine comprises at least one rotor element which can be driven by the wind, an output load, particularly a generator, and a pump driven by the rotor element wherein the output of the pump is connected to the output load.

In the present invention, a rotor element is connected to a hydraulic pump either directly or by means of an intermediate transmission in each case. The rotary movement of the rotor element is converted in the hydraulic pump to hydraulic pressure, which is passed to an output load via lines which are preferably routed in the interior of the pylon of the wind power machine to its base area. The hydraulic pressure is preferably supplied to a converter, which converts pressure energy from the hydraulic pressure that has been built up to a rotary movement in order to drive any desired output load, preferably a generator. The hydraulic fluid is supplied back to the hydraulic pump in the pylon attachment via an appropriate return line.

Hydraulic pumps such as these are considerably smaller and more cost-effective, and are easier to produce and to operate than conventional wind power machines with generators in the pylon attachment. The hydraulic pumps can thus be inserted into a pylon attachment of a wind power machine quite easily, and with virtually no maintenance, and can be connected to a rotor shaft of the rotor element.

One advantage of the present invention in this case is that the output load, which may be any desired output load, but is preferably a generator, can be arranged close to the ground or in the base area of the pylon, or in the ground area away from the pylon.

The output load can then easily be maintained and replaced, if necessary, in the event of wear.

A further significant advantage is that two or more wind power machines, possibly also of different types or in a wind park, can be connected to the single converter and to the single output load, in particular a generator, so that only one generator need be provided in order to convert the pressure energy that is produced from the hydraulic pumps to electrical energy.

This allows wind parks to be designed, operated and maintained at a considerably lower cost.

Furthermore, it has been found to be advantageous to insert a restriction element into the line for control purposes, in particular in order to limit the rotation speed of the rotor element for critical rotation speeds, which restriction element can be controlled such that a critical rotor element speed can be regulated via the flow rate through the restriction. This allows the rotor element to be braked very easily, without wear and at low cost. There is therefore no need for costly, heavy, conventional brakes.

The insertion of controllable valves into the line as well as the return line, or possibly in the hydraulic pump itself, also allows the rotor element to be fixed such that it cannot rotate, and the wind power machine can be switched on in a simple and cost-effective manner, without any wear. This is likewise intended to be within the scope of the present invention.

The scope of the present invention is also intended to cover the fact that a pump, for example, may be connected as the output load. This pump can be used, for example, to pump water to a reservoir which is at a higher energy level in order, for example, to drive a turbine, which is at a lower level and is connected to a generator for electricity generation by means of this water that is at a higher level, for example at peak load times. By way of example, this allows energy to be provided very quickly at peak load times, if, for example, the wind power machines are emitting relatively low power outputs. Thus, overall, a wind power machine, in particular a wind park, can be designed which also makes it possible for the wind power machine or wind park to provide an influence in the event of different power levels, winds, lack of wind or at peak load times.

With the present invention, it has also been found to be particularly advantageous that two or more hydraulic pumps can be associated with a single wind power machine, in which case, if required, the hydraulic pumps may be subdivided into different power groups. The individual hydraulic pumps can be driven or regulated on the basis of the rotation speed or as a function of the power output of the rotor element, so that the rotor element can be driven even by very high wind speeds or extremely low wind speeds and a rated rotation speed can be regulated, in particular controlled, on the basis of the pumps which can be connected. This allows the energy yield to be optimized with regard to the Weibull distribution, so that an optimum yield and conversion of the wind energy are possible over wide ranges.

Furthermore, it has been found to be advantageous for it to be possible to supply two or more output loads or generators from one or at least two or more wind power machines, so that the output loads or generators can be operated, if required, with upstream converters on a correspondingly power-output specific or pressure-specific basis. In this case, for example, generators can be provided in different power output levels and in different quantities, for example 100 kW, 250 kW, 350 kW, etc, in a wind park, and can be connected directly to a number of wind power machines, so that small generators with a relatively low power output can be operated optimally and with optimized efficiency for low power output ranges when there is little wind. This is likewise intended to be within the scope of the present invention.

Furthermore, it has been found to be advantageous that the very light pylon attachment 4 means that there is no need to align it in a positively controlled manner by means of electric motors or the like with respect to the wind, but that it can be operated mechanically, possibly by means of rudder control. This is likewise a considerable advantage of the present invention.

### BRIEF DESCRIPTION OF THE DRAWINGS

Further advantages, features and details of the invention will become evident from the following description of preferred exemplary embodiments and from the drawing, in which:

FIG. 1 shows a schematically illustrated side view of a wind power machine according to the invention;

FIG. 2 shows a schematically illustrated side view of a number of wind power machines;

FIG. 3 shows a schematically illustrated plan view of a number of wind power machines;

FIG. 4 shows a schematically illustrated side view of a further exemplary embodiment of a wind power machine as shown in FIG. 1;

FIG. 5 shows a schematically illustrated side view of a wind power machine as shown in FIG. 4, connected to a number of generators or output loads;

FIG. 6 shows a schematically illustrated plan view of a further exemplary embodiment of a number of wind power machines as a further exemplary embodiment as shown in FIG. 3.

### DETAILED DESCRIPTION

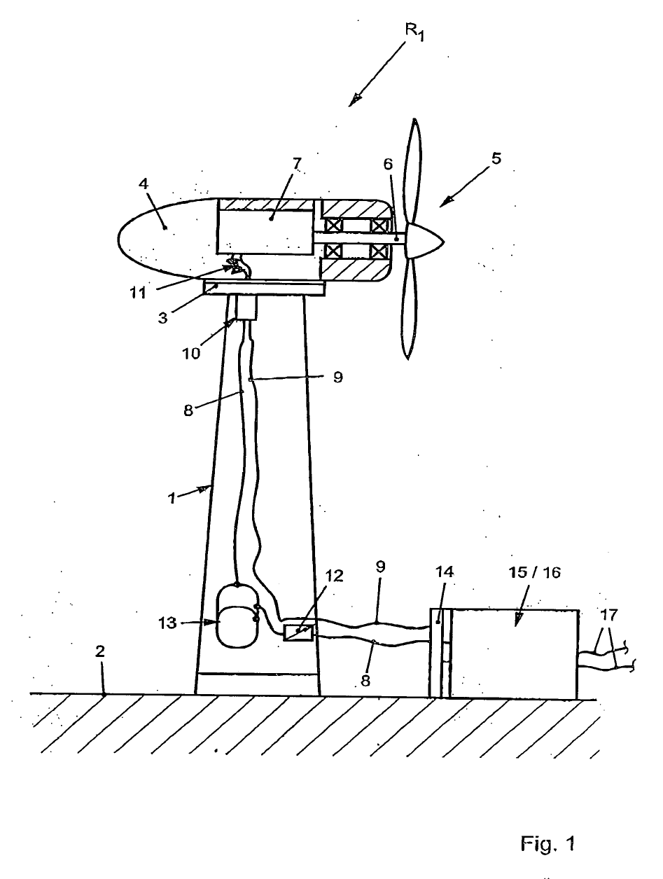

As is shown in FIG. 1, a wind power machine R₁ according to the invention has a pylon 1 which is installed on a base 2. The pylon 1 is seated on a pylon attachment 4 via a bearing element 3 such that it can rotate, and the pylon attachment 4 is fitted with at least one rotor element 5.

The rotor element 5 is driven by the wind such that it rotates about a rotor shaft 6.

According to the invention, the rotor shaft 6, and hence the rotor element 5, are connected to a hydraulic pump 7. The rotational movement of the rotor element 5 and of the rotor shaft 6 allows the hydraulic pump 7 to be driven and to produce a hydraulic pressure, which is passed on via a first line 8. A return line 9 is furthermore likewise connected to the hydraulic pump 7.

The line 8 and the return line 9 between the hydraulic pump 7 preferably open into a coupling 10, which compensates for and equalizes any rotational movement of the pylon attachment 4 with respect to the rigid pylon 1.

A restriction element 11, in particular a controllable restriction, is preferably inserted into the line 8 between the coupling 10 and the hydraulic pump 7, although a controllable valve 12 may also be inserted into the line 8, additionally or alternatively, or, as is illustrated in FIG. 1, close to the base 2.

It is also intended to be within the scope of the invention for a pressure equalization device 13, in particular a pressure equalization container, to be inserted in the line 8. The line 8 or the return line 9 are preferably connected to an externally mounted converter 14, which is connected to the output load 15 or generator 16, as illustrated in particular in FIG. 1, with the converter 14 converting the pressure energy that is produced by the hydraulic pump 7 to a rotary movement in order to drive the output load 15, preferably the generator 16, in order to generate electricity. The generator 16 can pass on the energy that is produced via a network feeder 17. In this case, the present invention is also intended to include the aim of arranging the output load 15, in particular the generator 16, within the pylon 1, or to accommodate it there.

A further important feature of the present invention is that the output load 15 or generator 16 can be installed nearby in the area of the base 2 of the pylon 1, or externally away from the pylon 1. This considerably reduces the weight, in particular of the pylon attachment 4, since a hydraulic pump 7 is considerably lighter than a conventional generator.

A further advantage of the present invention is that the restriction 11 allows the flow rate in the line 8 to be controlled exactly. This makes it possible, for example, to regulate out or limit a critical speed of the rotor element 5. The restriction 11, which is connected to a controller that is not illustrated here, can thus brake the rotor element 5, in particular by limiting the flow through the hydraulic pump 7.

Switching off, for example for maintenance purposes, is also feasible easily, for example by closing the valve 12, which is not illustrated here, via a controller, with the rotor element 5, and hence the hydraulic pump 7 stopped in this way.

In this case, it is also intended to be within the scope of the present invention for the valve 12 to be inserted into the line 8 and/or return line 9, for example between the coupling 10 and the hydraulic pump 7. The invention is not restricted to this.

In order to compensate for pulsations in the line 8 and/or return line 9 and gusty wind loads on the rotor element 5, it has been found to be advantageous to preferably insert a pressure equalization container 13 into the line 8.

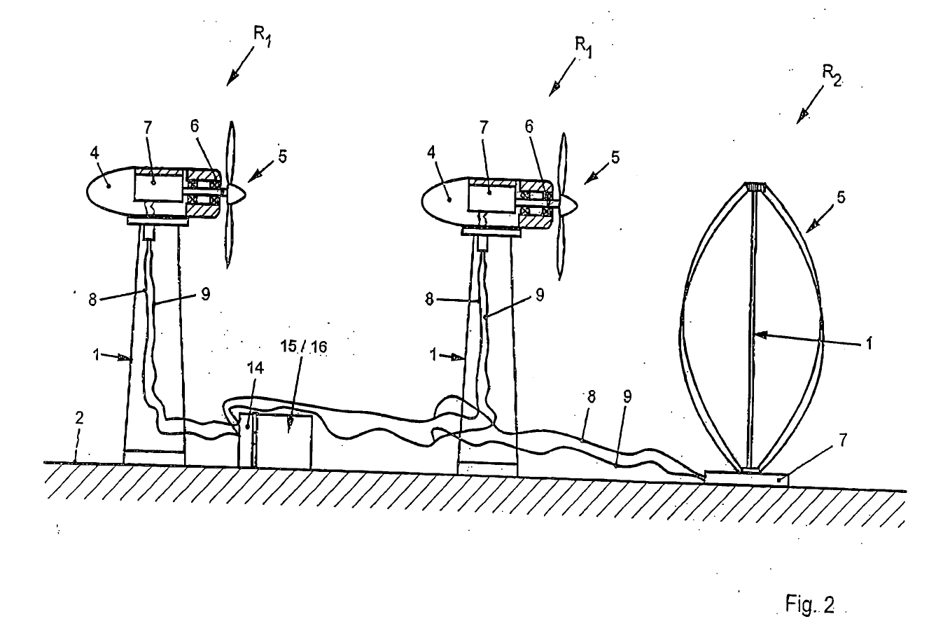

In the exemplary embodiment of the present invention shown in FIG. 2, a number of wind power machines R₁, R₂ are positioned on a base 2 in a wind park, in which case it is also intended to be within the scope of the present invention for wind power machines R₁, R₂ of different types to be operated in the manner described above. In this case, the wind power machine R₂ may have rotor elements 5 which revolve radially around the pylon 1 and drive the hydraulic pump 7 in the manner described above.

The corresponding lines 8 and return lines 9 may be used, for example, to connect two or more wind power machines R₁, R₂ to at least one converter 14 for an output load 15, preferably a generator 16, so that the overall costs for a wind park can also be considerably reduced by using a small number of generators 16, or only a single generator 16, when using two or more wind power machines R₁, R₂.

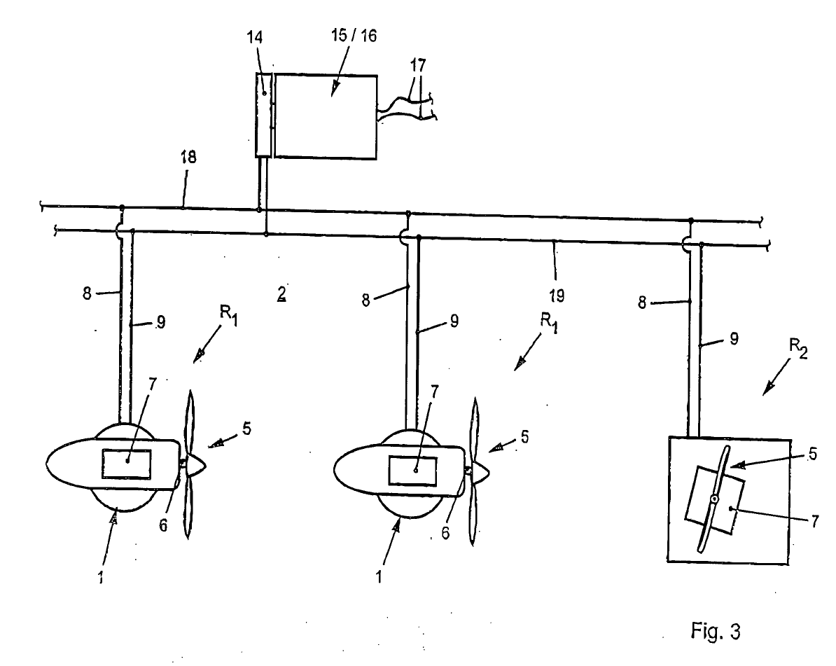

The exemplary embodiment of the present invention as shown in FIG. 3 illustrates how two or more wind power machines R₁, R₂ can be connected in parallel via the lines 8, 9 to a common supply line 18 and common return lines 19, which are connected to the converter 14.

This also makes it possible, for example, to provide pressure equalization between individual wind power machines R₁, R₂, so that the converter 14 is provided with a continuous pressure and a continuous drive power level for driving the output load 15 or generator 16.

In this case, it is feasible to insert non-return valves into the individual lines 8.

It is also possible for two or more converters 14 with generators 16 connected to them to be connected to two or more wind power machines, in order to produce a very high output power level.

It is also intended to be feasible to connect two or more output loads 15 or generators 16 to the converter 14. The invention is not restricted to this.

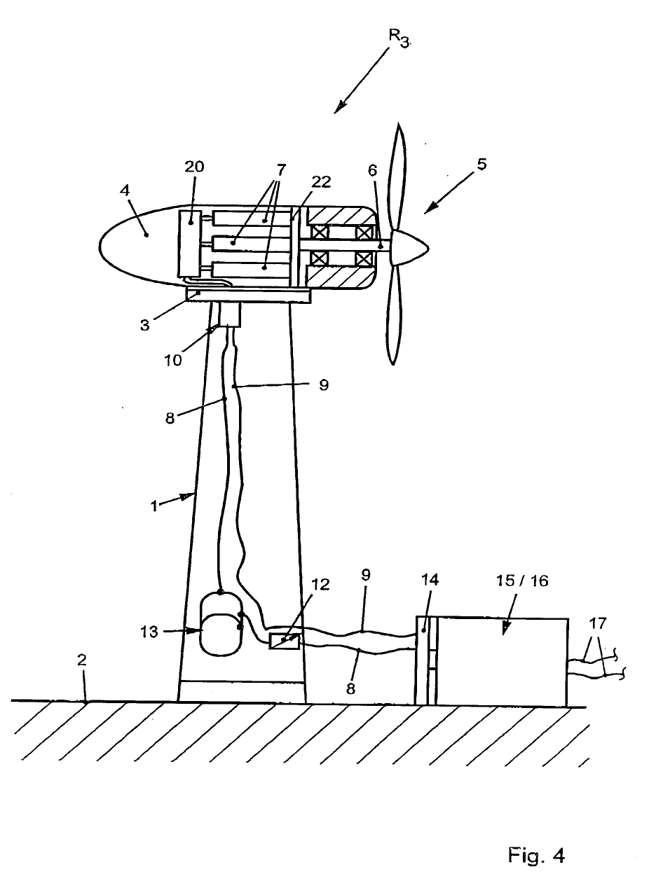

In a further preferred exemplary embodiment of the present invention as shown in FIG. 4, a wind power machine R₃ is illustrated which, as shown in FIG. 1, corresponds approximately to the wind power machine R₁.

The difference is that the wind power machine R₃ has two or more associated hydraulic pumps 7 in the pylon attachment 4.

In this case, the individual hydraulic pumps are connected to the rotor shaft 6 of the rotor element 5, preferably via a common transmission element 22.

Toothed belts, epicyclic gears, gear wheels or the like may be used as the transmission element 22 in order to connect or couple the individual hydraulic pumps 7 to the rotary movement of the rotor shaft 6 of the rotor element 5 directly or with a step-up ratio which can be selected.

However, one important factor with regard to the present invention is that the individual hydraulic pumps 7 can be connected selectively, depending on the rotation speed of the rotor element 5 via a regulation device 20, which is likewise preferably provided in the pylon attachment 4.

A further important feature of the present invention is that the individual hydraulic pumps 7 are provided, for example, in different power levels in the wind power machine R₃ or in the pylon attachment 4.

This means that the rotor element 5 can always be operated at a rated rotation speed which can be selected, so that this also makes it possible to make optimum use of regions with high wind strengths. This makes it possible to avoid high rotation speeds of the rotor element 5, and the rotation speed of the rotor element 5 can be controlled or restricted optimally in all wind strength ranges, so that the power output yield is optimized in all wind strength ranges. From one to all of the hydraulic pumps may also be connected in a combined form for this purpose.

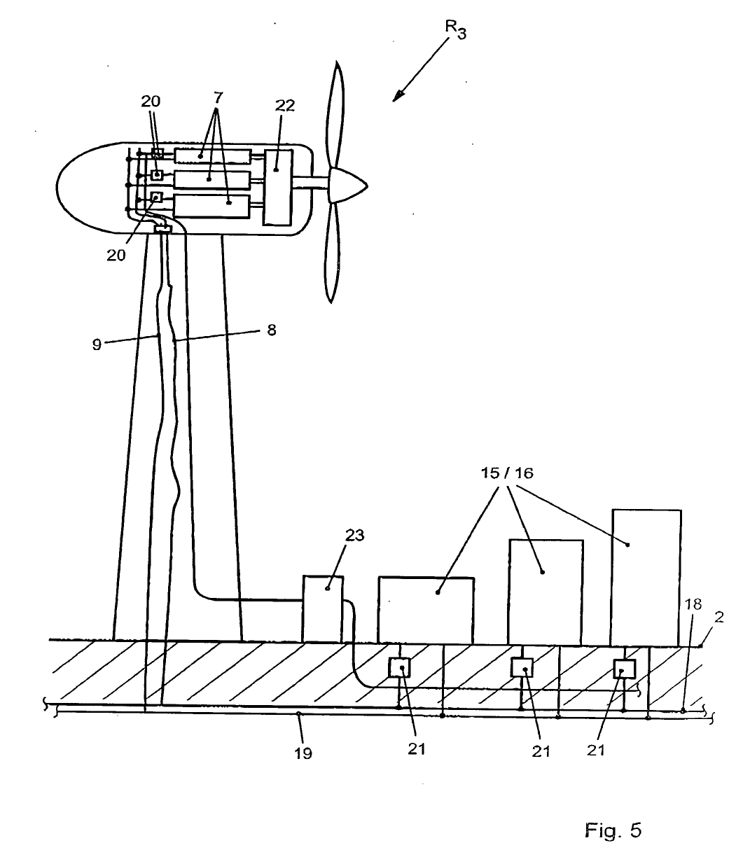

In the exemplary embodiment of the present invention shown in FIG. 5, a similar exemplary embodiment is used to show that two or more output loads 15 or generators 16 can be connected to at least one wind power machine R₃, with the individual output loads 15 or generators 16 being connected via control devices 21, which are indicated here, with a common line 8 or return line 9 of the wind power machine R₃ via a common supply line 18 and a common return line 19.

In this case as well, it is advantageous that different output loads 15 or generators 16, for example with different output power levels, can be connected selectively, in particular with the capability to be controlled via a common monitoring unit 23, on a power-output specific basis depending on the power output of the at least one wind power machine R₃, which power output is fed in the form of a pressurized medium into the supply line 18 and return line 19.

This ensures that, when the wind strengths are extremely low, only one output load 15 or generator 16 whose power output is low is fed, so that, even in this case, the power output, in particular the generator, is used in an optimized manner.

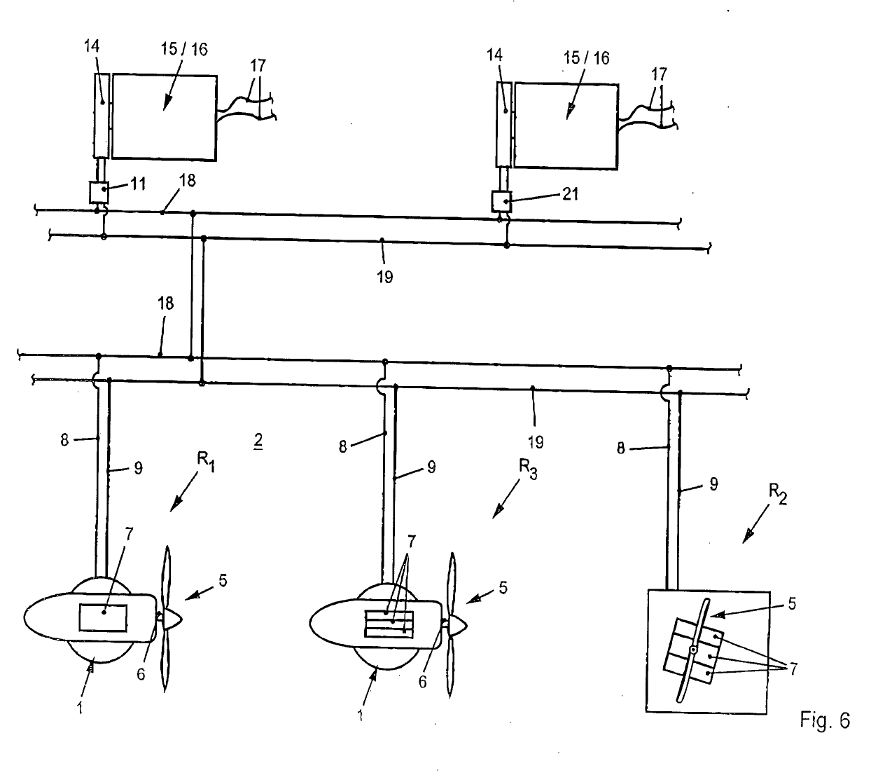

In this case, it is also intended to be within the scope of the present invention, as is illustrated in FIG. 6, for two or more output loads 15 or generators 16 to each be connected separately via control devices 21 to two or more hydraulic pumps 7 and wind power machines R₁ to R₃, in which case each individual wind power machine R₁ to R₃ can be controlled on a wind-specific basis via two or more hydraulic pumps in order to produce an optimized power output, in which case power-output specific output loads 15 and/or generators 16 can be connected individually, together, in particular controllable and selectively via control devices 21.

1-21. (canceled)

22. A wind power machine for the production of energy comprising:
a rotor element;
a plurality of hydraulic pumps driven by the rotor element;
a transmission means positioned between the rotor element and the plurality of hydraulic pumps for drivingly connecting the rotor element to the plurality of hydraulic pumps; and
regulation means for selectively connecting an output from the hydraulic pumps as a function of at least one of torque and rotation speed of the rotor element.

23. A wind power machine for production of energy, having at least one rotor element which can be driven by the wind and having an output load, in particular a generator, which is connected directly or indirectly to the rotor element, characterized in that two or more wind power machines with two or more hydraulic pumps feed two or more generators and/or output loads in a manner which can be controlled as a function of the power output level, the at least one generator and/or output load is subdivided into different power levels, and can be distributed to the at least one generator and/or output load on a power-output specific basis via at least one control device depending on the power which is emitted by the wind power machines (R₁ to R₃).

24. The wind power machine as claimed in claim 22 or 23, characterized in that two or more wind power machines have two or more hydraulic pumps which can be connected and supply, on a power-specific basis, two or more generators and/or output loads which can be connected and can be controlled.

25. The wind power machine as claimed in claim 24, characterized in that the two or more hydraulic pumps can be connected selectively via controllable control devices for power optimization, with the hydraulic pumps being arranged in different power levels in the pylon attachment.

26. The wind power machine as claimed in claim 25, characterized in that two or more generators and/or output loads can be driven via a monitoring unit in different power output level levels of at least one wind power machine (R₁ to R₃), in particular of at least one hydraulic pump, in each case individually controllable and at least partially as a function of the power output level and/or pressure.

27. The wind power machine as claimed in claim 26, characterized in that the at least one hydraulic pump is connected to an output load, in particular to a generator, and drives it.

28. The wind power machine as claimed in claim 27, characterized in that the output load, in particular the generator, can be driven externally by the wind power machine, in particular by the rotor element via the hydraulic pump.

29. The wind power machine as claimed in claim 28, characterized in that two or more individual wind power machines (R₁, R₂) can be connected by means of rotor elements and connected hydraulic pumps to a common output load, in particular to a common generator, and drive it.

30. The wind power machine as claimed in claim 29, characterized in that the hydraulic pump is connected directly to the rotor element and is connected via lines to a converter for a generator, with the converter driving the generator.

31. The wind power machine as claimed in claim 30, characterized in that a controllable restriction element and/or a controllable valve is inserted in at least one line for open-loop and/or closed-loop control and/or for braking.

32. The wind power machine as claimed in claim 30, characterized in that at least one pressure equalization device, in particular a pressure equalization container for pressure and/or pulsation equalization, is inserted between the hydraulic pump and the output load, in particular the generator (16).

33. The wind power machine as claimed in claim 32, characterized in that the rotor element drives the hydraulic pump via a rotor shaft.

34. The wind power machine as claimed in claim 33, characterized in that this wind power machine has a pylon and, at its end, a pylon attachment which can rotate, with the rotor element being mounted in the pylon attachment such that it can rotate, and being connected to the hydraulic pump there.

35. The wind power machine as claimed in claim 34, characterized in that the lines are passed via a coupling, such that they are decoupled in terms of rotation, through the pylon to an output load, in particular a generator, which is arranged in the pylon, on the pylon or externally from the pylon.

36. The wind power machine as claimed in claim 35, characterized in that two or more hydraulic pumps for different wind power machines (R₁, R₂) can be connected to at least one generator.

37. The wind power machine as claimed in claim 36, characterized in that two or more wind power machines (R₁, R₂) can each be connected via a line and a return line to a common supply line and to a common return line, to which at least one converter is connected, and to which converter at least one output load and/or generator is connected.

38. The wind power machine as claimed in claim 37, characterized in that the output load is in the form of a pump for feeding the water to a reservoir at a higher level.

39. The wind power machine as claimed in claim 38, characterized in that the reservoir which is at a higher level is connected to a turbine, which is at the lower level, for driving a generator.
